(19) United States
(12) Patent Application Publication
(10) Pub. No.: US 2014/0158753 A1
(43) Pub. Date: Jun. 12, 2014

(54) SYSTEM AND METHOD FOR OBTAINING INFORMATION ELECTRONICALLY USING A CODED INDICIUM ASSOCIATED WITH A RECIPE

(71) Applicant: KERRY P. SISSELMAN, HOLLYWOOD, FL (US)

(72) Inventor: KERRY P. SISSELMAN, HOLLYWOOD, FL (US)

(21) Appl. No.: 13/709,737

(22) Filed: Dec. 10, 2012

(51) Int. Cl. G06F 17/30; G06K 1/12

(52) U.S. Cl. CPC G06F 17/30002; G06K 1/121
USPC 235/375; 235/487

(57) ABSTRACT

A system and method are provided for electronically obtaining information about a recipe utilizing a coded indicia associated with and/or printed or published with the recipe. In this system, a coded indicium including encoded information representing information related to the recipe, including, but not limited to, ingredient lists, cooking steps, notes, nutritional information and/or a URL or hyperlink. One such indicia can be a two-dimensional (2D) barcode, such as a QR code, published with a paper based recipe.

### BACKGROUND OF THE INVENTION

1. Field of the Invention

The present invention relates to an application, system and method for electronically obtaining and/or manipulating information related to a paper based recipe found in a newspaper, cookbook, food magazine or other paper based print publication and more particularly, to an application, system and method that utilizes a printed indicia associated with and/or accompanying a paper based recipe to permit the electronic use and manipulation of information pertaining to a recipe provided in a paper based format.

2. Description of the Related Art

The publication of printed cookbooks and food related magazines is a big industry. Despite the proliferation of electronic books or “e-books”, the market for printed cookbooks and food related magazines continues. According to one recently published article by Helen Hecker, cookbook buyers “really don't have time to cook, but love to read recipes, read about cooking and food, and collect useful and beautiful cookbooks”. Ms. Hecker additionally states “[t]he average American woman owns about 15 cookbooks and three out of ten women collect cookbooks”. Although desirable for any number of reasons, paper based cookbooks, recipes and food magazines are static—the recipes they contain are not easily manipulated without requiring the user to write or type the information into another format. For example, in order to shop for the items required to execute a paper based recipe, either the recipe must be brought to the store (as a photocopy or with the cookbook or magazine in which the recipe appears) or the ingredients list must be transcribed into another medium, either by writing the ingredients list into a paper based shopping list, typing the ingredients list into a shopping list program for an electronic device, such as a smart phone or tablet, or even, by photographing the recipe with a camera on a smart phone for referencing while at the grocery store. Additionally, such transcription must also be performed if a user wants to save a recipe a particular recipe for future reference. For example, if the user has a favorite recipe in a paper based cookbook, that single recipe can be transferred to a paper based recipe card (by handwriting, copying or printing), or photocopied and placed into a binder or recipe box. There is a need for such information and recipes from print based recipe books and publications to be made easily available electronically, for manipulation by a user.

A number of smart phone and tablet based applications or “Apps” are available for use in electronically finding recipes meeting certain criteria and/or for creating shopping lists. Certain shopping list apps permit the entry of shopping list items, by typing or speaking the name of the desired item into window of the app, or by scanning the barcode on the product packaging of an item. For example, one such app called Grocery IQ provides a product barcode scanner, list sharing, integrated coupons and the ability to edit a shopping list online. Such apps require populating the shopping list one product at a time (i.e., by scanning a barcode on a can of corn, 1 can of corn is entered into the shopping list), and not through the use of a recipe.

BIGOVEN®.com (www.bigoven.com) offers a service in which members can organize their recipes, including: putting their recipes in the “cloud”; resizing recipes up or down; making sorted grocery lists; saving and editing any recipe; and creating and sharing menus with other cooks. Additionally according to the BIGOVEN® website, users can type in their own recipes for free, but “if you'd like, we can type them in for you”. The BIGOVEN® website states “[w]ith BigOven's RecipeScan, you simply snap a photo and we'll type in the recipe for you. You get 3 free to try, and 25 more free if you join BigOven PRO. Additional RecipeScan credits can be purchased starting at just $0.59 per recipe”. The BIGOVEN website additionally states, in part: “1. [j]ust submit a photo of a hand-written or typed recipe, using your camera scanner or our free iPhone, iPad, Android or Windows Phone apps. 2. BigOven will convert your photo to digital text to save you typing! 3. View and search all your recipes on our website and free mobile apps. BigOven Pro members also can easily make grocery lists and get nutrition facts right from the scans! Online or electronic recipe apps, however, do not provide the user with the ability or pleasure of sitting down and leafing through a paper based cookbook or cooking magazine.

In the past, compressed codes listed in a television calendar or schedule, schedule television program recording. See, for example, U.S. Pat. Nos. 5,307,173, 5,335,079 and 5,532,732 to Henry Yuen and Daniel Kwoh. These codes were provided in the paper based TV Guide and/or newspaper, as “VCRPLUS” codes. However, such codes were not used to produce information manipulatable by a user. Further they were not provided in association with recipes, nor did they relate to recipes with which they were provided.

Also in the television related field, U.S. Pat. No. 8,191,091 to Harvey and Cuddihy (“the '091 patent”) gives an example wherein a code (i.e., “TV567#”) displayed on the television as part of a transmission of “Exotic Meals of India” television programming is entered by a user on their “Widget Signal Generator and Local Input” and used by the user's TV signal decoder to capture later transmitted “generate-recipe-and-shopping-list instructions” embedded in the television transmission. Executing the generate-recipe-and-shopping-list instructions causes a microcomputer to generate information of the specific fish curry recipe and fish curry shopping list of the family of the subscriber of the station; to cause the recipe and shopping list to be printed at a printer; and to retain information of the shopping list at particular memory. However, the code (“TV567#” of the '091 patent) did not actually include the coded information related to the recipe, but rather, was used to inform the TV signal decoder to capture information transmitted late in the television broadcast signal (or in a different transmission) from which the recipe and shopping list could be generated by a microcomputer of the '091 patent.

What is needed is a system and method permitting a user to convert a scanned, coded indicia associated with a recipe into electronically manipulatable data such as a shopping list or recipe bank, in realtime, i.e., without the need to send it away to be typed in, waited for in a television signal and/or without the need for a monthly or per item membership fee for transcribing recipes or scanning in the items by scanning one product barcode at a time.

### SUMMARY OF THE INVENTION

A system and method are provided for electronically obtaining information from a recipe utilizing a coded indicium associated with and published with the recipe. In one particular embodiment of the invention, a recipe is published in a paper based book, newspaper or magazine with a coded indicium including encoded information constituting information in the recipe. For example, such encoded information can include, but is not limited to ingredient lists, cooking steps, notes, nutritional information and/or a URL or hyperlink. In one particular embodiment of the invention the indicia is a two-dimensional (2D) barcode, such as a QR code or VSCode® symbol or a stacked linear barcode. In another particular embodiment of the invention, the coded indicia, itself, includes the recipe information used by the system.

Other features which are considered as characteristic for the invention are set forth in the drawings and the appended claim.

Although the invention is illustrated and described herein as embodied in a System And Method For Obtaining Information Electronically Using A Coded Indicium Associated With A Recipe, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWINGS

For a fuller understanding of the nature of the present invention, reference should be made to the following detailed description, taken in connection with the accompanying drawings in which:

FIG. 1 is an illustration of a paper based recipe including a coded indicium published on the same page as a recipe to which the indicia is related, in accordance with one particular embodiment of the invention;

FIG. 2 is a perspective view of a system for reading coded indicia associated with and/or accompanying paper based recipes in accordance with one particular embodiment of the invention;

FIG. 3 is a simplified block diagram of a system in accordance with one particular embodiment of the invention;

FIG. 4 is a flow diagram of a method of associating a coded indicium with a recipe in accordance with one particular embodiment of the invention;

FIG. 5 represents information used to generate an indicium in accordance with one particular embodiment of the present invention;

FIG. 6 represents information used to generate an indicium in accordance with one particular embodiment of the present invention;

FIG. 7 is a flow diagram of a method of using a coded indicium in accordance with one particular embodiment of the invention;

FIG. 8 is an illustration of a device running an application in accordance with one particular embodiment of the invention; and

FIG. 9 is a general flow diagram of one particular embodiment of a method useful in accordance with the present invention.

### DETAILED DESCRIPTION OF THE PREFERRED EMBODIMENT

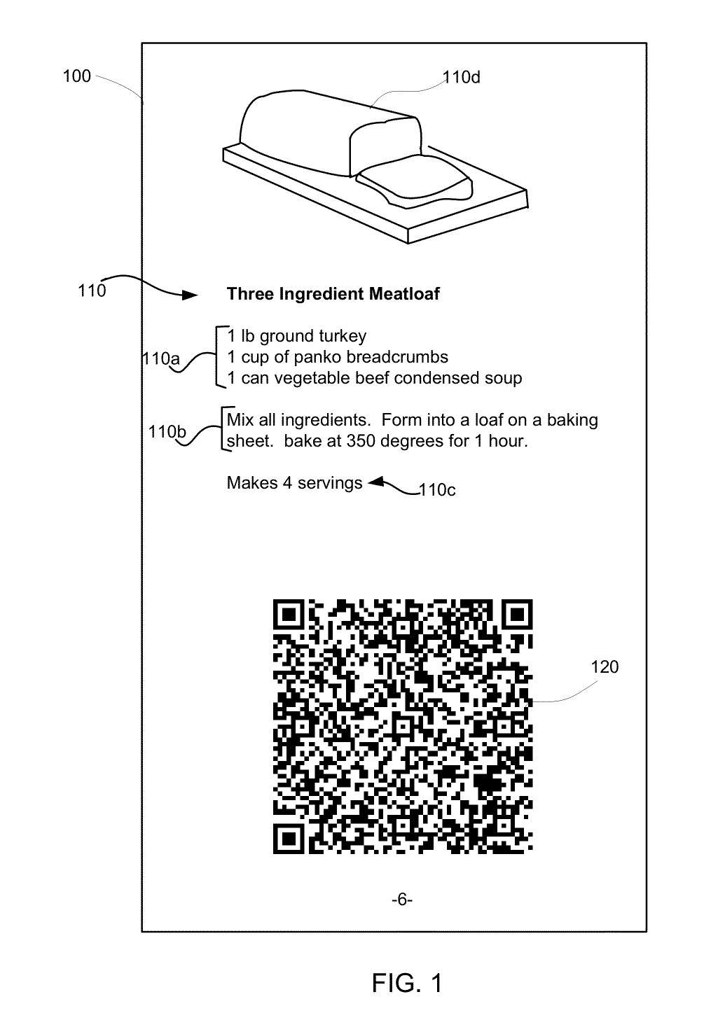

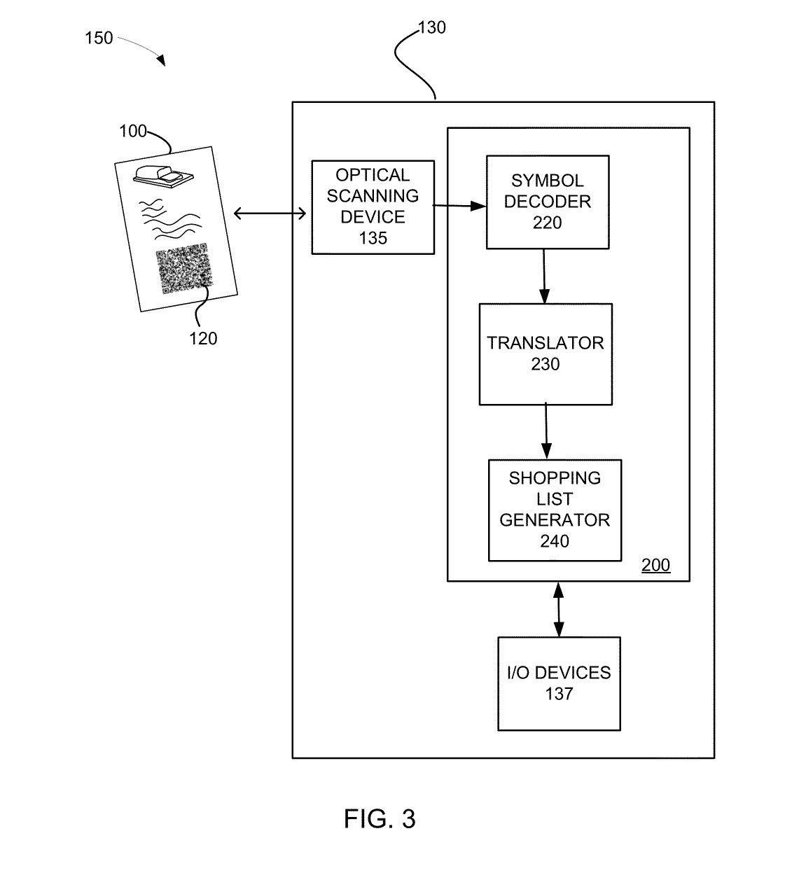

Referring now to FIGS. 1-3, there is shown recipe 110, printed on a paper 100. Recipes are available in a wide variety of paper based publications, such as in cookbooks, magazines and newspapers. Such recipes are published in a certain format, having a list of ingredients 110a, and their respective amounts, at the top, and instructions for the preparation of the recipe 110b below the list of ingredients. Other information, such as nutritional information, author's notes 110c and/or pictures of the preparation steps and/or a photograph 110d of the finished product have also been provided on the printed page. Paper 100 can by any paper based publication 140, including, but not limited to, a paper based cookbook, a page printed from the internet and/or a page from a magazine or newspaper. Note that, in an alternate particular embodiment of the invention, the indicia can be published or printed with the recipe electronically, for example, not on paper, but on an electronic display instead of on page 100.

A coded indicium 120 is printed on the paper 100 with the recipe 110. The coded indicium 120 contains information that is related to the recipe 110. In one particularly preferred embodiment of the invention, the coded indicium 120 includes coded information listing the ingredients required for preparing the recipe 110 in accordance with the printed instructions. In other words, in the present preferred embodiment, the coded indicium 120 itself includes coded information that, absent any further information from any other source, allows an application of the system to create a list of ingredients necessary for preparing the recipe 110, as printed. In its most basic form, the coded indicium 120 can be created from, and used to regenerate, a textual list of the ingredients and/or preparation steps for preparing the recipe as printed on the page 100. Thus, a portable device, such as a smartphone, tablet, PDA, etc., including an optical scanning mechanism or device 135, such as a camera, can be used to scan the coded indicium 120 to electronically reproduce information relating to the recipe in the portable electronic device 130. The system 150 of the invention includes the source 140 of the recipe 110 and the portable electronic device 130 including an optical scanning device 135. Software stored in the portable electronic device 130, and executed by a processor inside the portable electronic device 130, controls the scanning of the coded indicium 120 and the conversion of the indicium 120 to recipe related information useful to the user.

In one particularly preferred embodiment of the invention the coded indicium 120 is a matrix or 2D barcode, such as a Quick Response (QR) Code generated in accordance with International Standard ISO/IEC 18004:2000(E), that International Standard being incorporated herein, by reference, in its entirety. Other types of 2D barcodes are known and may be used, including, but not limited to the VSCODE Symbol by Veritec Inc. Alternately, a stacked linear or 1D barcode, such as PDF417 by Symbol Technologies, or other type of code containing a sufficient amount of usable data bits may be used. A number of readers are available to read such 2D barcodes and indicia. In the present preferred embodiment, an application 200 or “app” running on the portable electronic device 130 is configured to capture (i.e., using the optical scanning device or camera 135) the indicium 120 and decode the information coded therein. The information directly pertains information needed for the preparation of the recipe, such as actual ingredients, steps for preparation, etc. In one particular embodiment of the invention, the information is derived from the printed portions of the recipe 110 and can be accessed by the user via the application 200 running on the portable electronic device 130, for example, to generate shopping lists and/or to catalog and share recipes.

More particularly, in the present preferred embodiment of the invention, at the time that a paper based recipe 110 is printed onto the paper 100, a coded indicium 120 associated with recipe 110 is additionally generated and printed. In the present preferred embodiment, the indicia 120 are printed onto the same page 100 as the recipe 110, as shown more particularly in FIGS. 1-3. However, in another embodiment of the invention, the indicia 120 for each of the recipes 110 in a publication 140 can be gathered together and printed on a different page or pages of the paper based publication 140, for example, as an appendix at the back of the publication 140, indexed by recipe title and/or page number. Thus, in the case where more than one recipe is printed in a paper based publication, such as in a cookbook or food magazine, the coded indicium 120 related to the recipe 110 is printed on paper somewhere in the same paper based publication as the associated recipe.

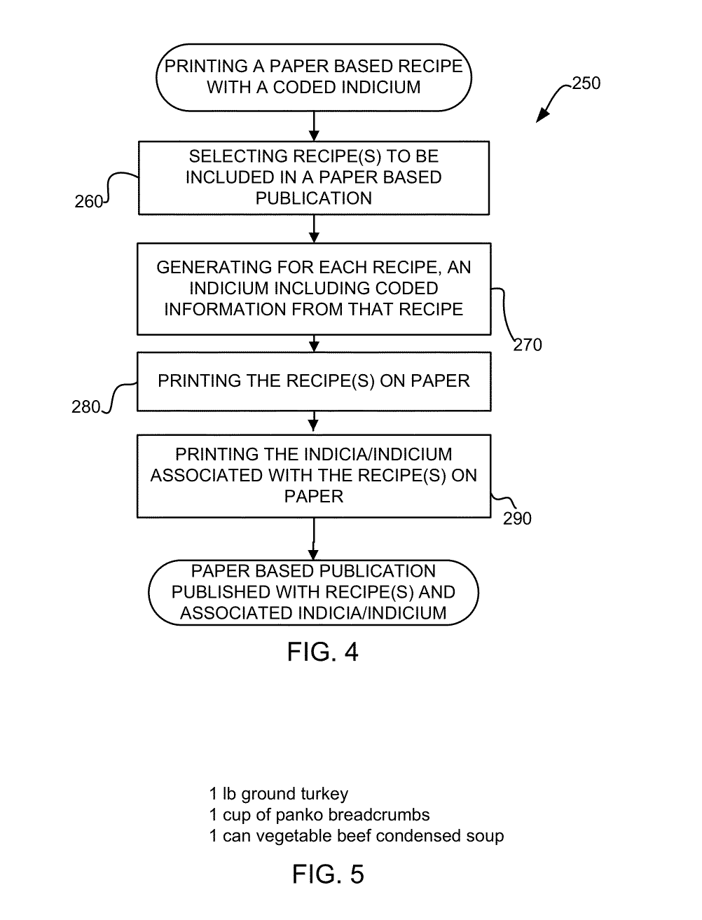

One method for printing a paper based recipe with a coded indicium 250 will now be described, more particularly, in connection with FIGS. 1-4. In creating a published recipe and coded indicium, the first step is to select the recipe or recipes to be published to paper. For example, a newspaper or magazine may run a weekly food column where a single recipe, or a group of recipes related by a theme, are published. In such a case, the author of the column would select the recipes, without any thought to the creation of the coded indicia. Step 260. Similarly, a cookbook may be prepared by the author, and the recipes selected, without any thought to the creation of the coded indicia.

Once the recipe or recipes 110 have been selected (step 260), information from the selected recipes are used to generate indicia 120 associated with, and unique to, each recipe 110. Step 270. For example, with regard to the three ingredient meatloaf recipe of FIG. 1, in one particular embodiment of the invention, the ingredients list (i.e., 1 lb ground turkey; 1 cup of panko breadcrumbs; 1 can vegetable beef condensed soup) is used to generate the coded indicium 120 of FIG. 1. In another embodiment of the invention, the ingredients list and the preparation steps are used to generate the indicium 120. In one particular embodiment of the invention, actual text from the recipe 110 is coded to generate the indicium 120. In another embodiment, the text of the recipe 110 is used to generate the indicium 120, which may include some or all of the text of the recipe 110, and/or information related to the text of the recipe 110.

More particularly, one particular example will be described in connection with FIGS. 1-6. For each recipe 110 selected, the publisher generates one associated indicium 120. The information selected for generating the indicium 120 is determined by the programming of the application 200, which will interpret and use the indicium 120. The publisher system can be set up to automatically generate an indicium 120 from the recipe 110, or the information needed for generating the indicium can be selected by the publisher, and may differ in some respects from the information printed on the page. For example, as discussed hereinabove, a recipe is printed in a particular format having certain defined blocks of text separated by spaces (i.e., title; ingredients list; preparation steps; notes; nutritional information). The system can automatically capture one or more of these text blocks, based on the spacing between them, in order to automatically capture the desired information and use it to generate an indicium 120 including the captured information. Alternately, the information used to generate the indicium 120 can be captured and/or entered manually.

In accordance with one embodiment of the present invention, information from the actual recipe 110 that will be printed on the page 100 will be used to generate the indicium 120. For example, if the application 200 is programmed by software to convert textual data decoded from the indicium 120 into a shopping list, the indicium 120 may be generated from text consisting of, or derived from, the ingredients list 110a, which when decoded produces a text list of information representing, or pertaining to, the preparation of the recipe (i.e., the ingredients list), as shown in FIG. 5.

In one particular example of the invention, the information (i.e., in this embodiment, the ingredients list) is coded in accordance with a standardized coding format, such as ISO/IEC 18004 to generate a coded indicium 120. The invention, however, is not intended to be limited to one particular coding standards, as any other coding standard producing a printable indicium 120 including coded information that is optically readable by an optical scanning device 135 of a portable electronic device 130 may be used. As discussed herein, in the most preferred embodiment, the indicium 120 is a 2D or stacked linear barcode in generated and decoded in accordance with a known standard.

In the present embodiment, the application 200 could decode the indicium 120 with the symbol decoder 220 to recreate the text list of FIG. 5, used to generate the indicium 120. First, the user directs the optical scanning device 135 (i.e., such as the camera of a smartphone), at the indicium 120 on the paper 100. As is known in the art with such publicly available barcode reading software, such as Red Laser and QRREADER, the user aligns the indicum 120′ (which is a realtime image of the indicium 120, as captured by the camera) in the frame 134 displayed on the display 132 (via the screen I/O devices 137) of the portable electronic device 130. Once focused in the frame 134, the indicium is captured and decoded by the symbol decoder 220, which may be barcode reading software operating on the device 130. If created from a text list, the symbol decoder will return the same text list used to create the indicium 120. A translator or processor 230 then processes the text list of FIG. 5 to identify individual items required for the preparation of the recipe 110. In the present example, the translator 230 could be programmed to recognize that each separate line in the text list (separated by a “return”) is a separate ingredient needed to prepare the recipe. The translator 230 can then provide each ingredient identified (i.e., turkey, panko breadcrumbs, soup) to the shopping list generator 240 for use in generating a shopping list including the identified ingredients, or adding the identified ingredients to the user's currently pending shopping list.

Note that other variations of the recipe information can be used to generate the indicium 120. For example, instead of the indicium 120 being generated consisting of the actual ingredients list 110a of the recipe 110, the text list could be created based on, but not identical to, the ingredients list 110a, i.e., specifying 1 8 oz can of panko breadcrumbs instead of one cup, as printed in the recipe 110. Such a difference between the printed recipe 110 and the information used to generate the printed indicium 120 could be helpful in creating the shopping list (i.e., which puts the ingredients list into purchasable units, rather than measured ones).

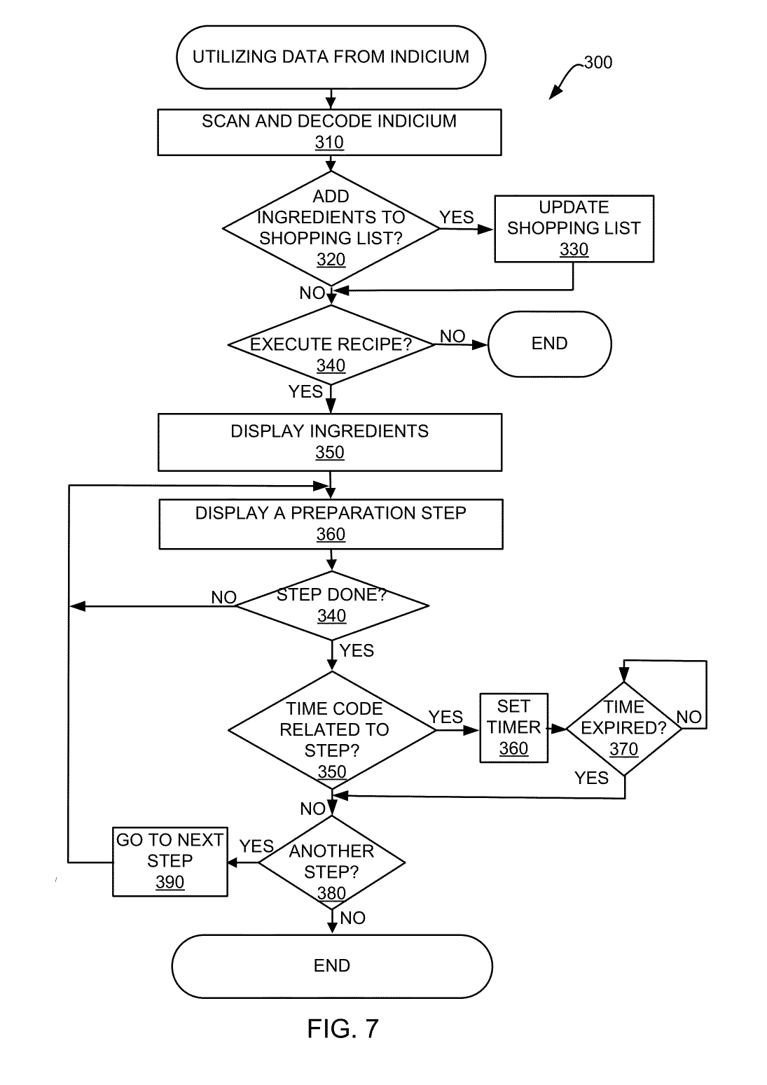

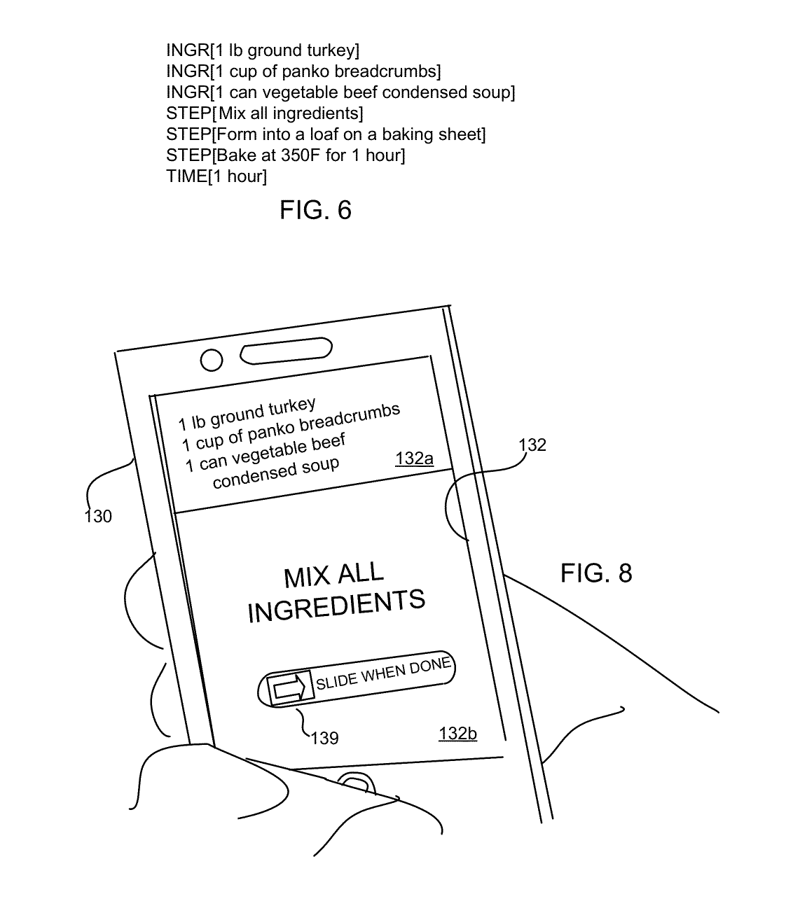

In another particular embodiment of the invention, the recipe information can be formatted to include special codes that inform the translator 230 of the kind of data being provided, so that the application 200 can handle the recovered data in a particular way. For example, referring now to FIG. 6, the recipe 110 of FIG. 1 can be prepared for coding by including identifier codes in connection with each of the recipe items. In particular a first code (such as INGR) can be used to identify ingredients list items, while another identifier code (such as STEP) can be used to identify preparation steps. Additionally, the coded indicium 120 can be used to provide programming instructions for the application 200. For example, FIG. 6 additionally includes an indentifier code “TIME” which can be used by the application code to program a timer or reminder, as will be described more particularly below.

Thus, a coder for the publisher prepares the information in the recipe 110 (submitted by the author) to include the separate codes for identifying the data types in the translator 230 for use by the application 200. The recipe data, including the identifier codes and, if desired, additional information, as shown in FIG. 6, is coded using a coding format that produces a 2D barcode or stacked linear barcode as indicium 120. When decoded by the app 200, the translator 230 recognizes the codes and process the data according to identifier code type. For example, in one particular embodiment of the invention, data prefaced by the identifier type INGR are sent to the shopping list generator 240, while other data types are not. Rather, the other data types can be used by the application 200 in other ways, as well. For example, application 200 can be programmed to, upon execution by a processor of the device 130, use the data encoded in the indicium 120 to assist the user in the preparation of the recipe 110.

Referring to FIGS. 1-4 and 6-9, one particular embodiment of a system 150 for obtaining and utilizing data from an indicium 120 will now be described. In order to obtain recipe related data or information from an indicium 120 printed with (i.e., on paper in the same publication as) a paper based recipe, the indicium 120 associated with the desired recipe must first be scanned. One particular embodiment of a method for performing such a scan is illustrated in FIG. 9. First, the user first loads a software application 200 on to an electronic device, preferably a portable electronic device 130, which has an optical scanning mechanism 135. Step 170 of FIG. 9. In the most preferred embodiment, the portable electronic device 130 is a smart phone, PDA or tablet (such as an Ipad) that includes a camera as the optical scanning mechanism 135.

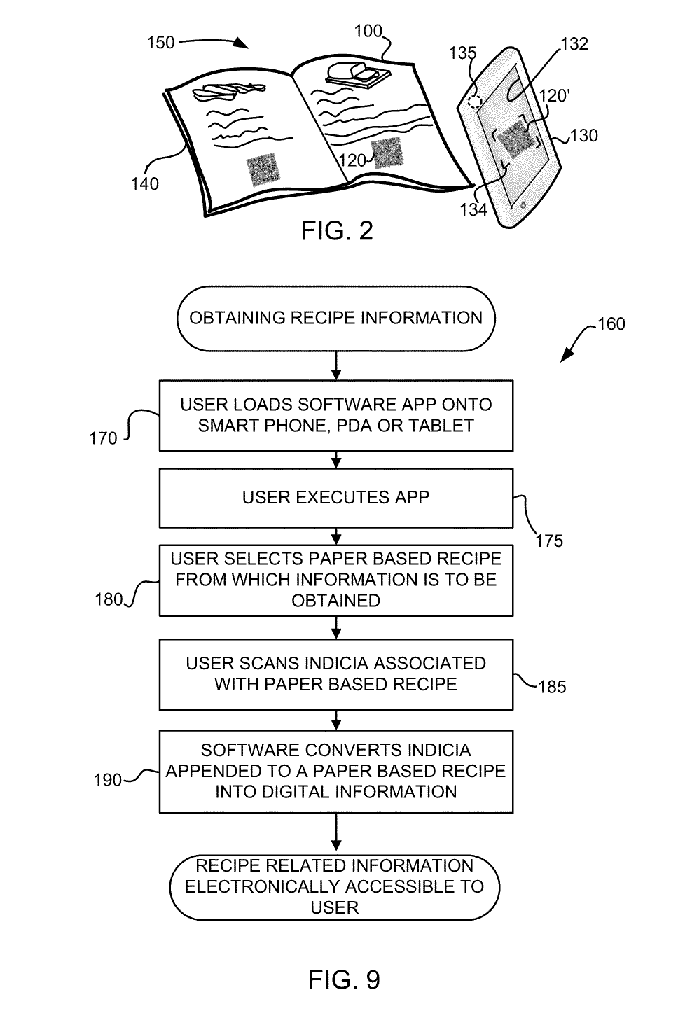

While the application 200 is being executed by the processor of the device 130, the user selects the paper based recipe from which information is to be obtained (step 180) and scans the indicium associated with the recipe (step 185). Such scanning can occur as described hereinabove in connection with FIG. 2. For example, the user can use the display 132 of the device 130 to align an image 120′ of the indicium 120 in the frame 134 displayed by the application 200, via the I/O devices 137, on the display 132. The symbol decoder 220 of the application 200 captures the indicium 120 and decodes the information using complementary steps to that used to encode the indicium 120. The digital information decoded from the indicium 120 can now be used by the application. Step 190 of FIG. 9.

More particularly, FIG. 7 illustrates one particular embodiment of a method 300 that the application can use the digital data decoded from the indicium 120. As discussed hereinabove, the device 130 is used to scan and decode a coded indicium 120 published with a recipe 110. The digital data obtained by the indicium can be text and/or instructions in a format usable by the application 200. For example, the translator 230 of the application 200 could be programmed to utilize textual data from the indicium to populate a shopping list, as described herein above, or even to guide the user through the preparation of the recipe.

Once scanned, the application determines if the information obtained from the indicium is to be added to a shopping list. Step 320. If yes, the application 200 updates the users presently pending shopping list, or generates a new one, if a presently pending list does not yet exist. Step 330. The application 200 can then determine whether the user wants to prepare the recipe that has been scanned. Step 340. If so, the application can utilize the display and/or other outputs (i.e., text-to-voice sound generation) to provide the user with the recipe information. In one particular embodiment of the invention, the display 132 can, optionally, display a split screen with a scrollable ingredients list displayed in one portion 132a (step 350) and a preparation step displayed in another portion 132b (step 360). In such a display, as an ingredient is used, the user and/or the application may delete the ingredient, or even decrement the amount of ingredient used, from the ingredient list displayed in the first portion of the display 132.

The application 200 may continue to display the current preparation step until the user indicates that the current preparation step has been completed (step 340). For example, the user may press or slide a soft button 139 displayed on the display 132 (read by the I/O devices 137) to inform the application that the current preparation step has been performed.

Additionally, when preparing the information coded as part of the indicium 120, the coder can input instructions that are useful to the application 200, but not displayed as part of the recipe. For example, in the decoded data shown in FIG. 6, the step “Bake at 350 F for 1 hour is displayed”. The user can actuate the soft button to indicate that the item for baking has been placed in the oven. The translator 230 sees that the “Bake” step is followed by a time code “TIME[1 hour]”. This code informs the application that, upon an indication of the completion by the user of the “Bake” step, the application 200 should set a timer or reminder to the user to expire in 1 hour. Thus, after each completed step, the system checks if the next instruction is a time code (step 50) and, if so, sets a timer (step 360) which will inform the user when the baking time (i.e., the time set by the application in accordance with the time code) has expired (step 370). Upon the expiration of such a timer, the user is informed, preferably by an audible alarm or indication, and the application checks whether or not another preparation step exists after the time instruction (step 380).

If another instruction exists, the application moves to the next step (step 390) and displays that step to the user until the user indicates that that step has been completed (step 360). Otherwise, the recipe is assumed to be completed and the application terminates execution of the recipe.

Please note that, in addition to the coded recipe information (i.e., information directly related to the preparation of the recipe, such as ingredient lists, recipe steps, notes, nutritional information, serving amounts, etc.) other information may be included in the coded indicia 120 without departing from the spirit of the invention. For example, in addition to, or instead of, the ingredient list, the coded indicium 120 can include a URL that directs the user to a website related to the recipe or hosted by the publisher and/or recipe author to provide more information about the recipe and/or about related publications that may interest the user based on the selection of a particular recipe. Additionally, the coded indicia 120 can include a coupon, or a URL that directs the user to a coupon, for ingredients required by the recipe. Similarly, the present invention would be useful in connection with the publication of limited run fundraising cookbooks, like those produced for booster organizations, temples and churches. In addition to the recipe information, the coded indicium could include information about the organization doing the fundraising, or about the member who provided the recipe, and/or a URL for the organization.

The present invention is additionally useful in connection with magazines and, more particularly, in connection with cooking or food related magazines. In particular, a paper based magazine can be published with one or more recipes including an associated indicium which, in addition to or instead of the recipe information, can include a URL that would take the user to a webpage set up by the magazine for that recipe, so that the user can read reviews and ratings for the recipe, add a comment or read other comments added by other readers of the magazine who have prepared the recipe. The same can, of course, by done with cookbooks in accordance with the present invention.

One particular advantage to the present invention is that recipes published in a static media, i.e., on paper based publications, can include indicia which provide valuable added digital content, programming and/or “bonus material” to the user at no significant added cost to the publisher.

Although described in connection with paper based recipes, it should be understood that coded indicia, as described herein, may also be included with online or electronic recipes, in order to more quickly enter the coded information related to a particular recipe departing from the scope of the present invention. The inclusion of such a coded indicium on an electronically available recipe additionally is useful in converting and storing information relating to that recipe with other information of the user in a portable electronic device (i.e., adding ingredients to, combining ingredients with, the users existing electronic shopping list) and/or in the event that the electronic recipe is printed and retained (such as in a recipe card box or binder).

The present disclosure is provided to allow practice of the invention, after the expiration of any patent granted hereon, by those skilled in the art without undue experimentation, and includes the best mode presently contemplated and the presently preferred embodiment. Nothing in this disclosure is to be taken to limit the scope of the invention, which is susceptible to numerous alterations, equivalents and substitutions without departing from the scope and spirit of the invention.

1. A method for obtaining recipe information, comprising the steps of:
electronically scanning a coded indicium published with a recipe to which the indicium relates;
decoding the indicium to obtain digital information including steps for preparing the recipe encoded in the indicium; and
utilizing the decoded digital information by software stored in a non-transitory memory of an electronic device and executed by a processor of the electronic device to guide a user through the decoded steps for preparing the recipe encoded in the indicium.

2. The method according to claim 1, wherein the digital information includes ingredients for preparing the recipe.

3. The method according to claim 2, further comprising the step of providing at least a portion of the digital information to an electronic shopping list application.

4. The method according to claim 1, wherein the digital information includes a list of steps to be performed for preparing the recipe.

5. The method according to claim 1, wherein the coded indicium and recipe are printed on paper.

6. The method according to claim 5, wherein the indicium is printed on a same page as the recipe in a paper based publication.

7. The method according to claim 5, wherein the indicium is printed on a different page from the recipe in a same paper based publication.

8. The method according to claim 1, wherein the indicium is a coded two dimensional barcode or stacked linear barcode.

9. The method according to claim 8, wherein the indicium is a Quick Response Code coded in accordance with International Standard ISO/IEC 18004.

10. A system for obtaining digital information from the coded indicium printed with a recipe to which the coded indicium relates, the system comprising:
an electronic device configured to perform the method according to claim 1;
said electronic device including an optical scanning device for scanning a coded indicium.

11. The system according to claim 10, wherein said optical scanning device is a camera and the electronic device is a portable electronic device including said camera.

12. The system according to claim 10, wherein the digital information includes ingredients for preparing the recipe and said electronic device is configured to make a shopping list including said ingredients.

13. (canceled)

14. A portable electronic device including a camera, said portable electronic device configured to:
scan a coded indicium printed with a related recipe;
decode the scanned indicium to obtain digital information including steps for preparing the recipe encoded in the indicium;
produce a list of ingredients and steps for preparing the recipe encoded in the indicium;
create an electronic shopping list including ingredients from said list of ingredients; and
utilize the decoded digital information to guide a user through the decoded steps for preparing the recipe encoded in the indicium.

15. The portable electronic device of claim 14 wherein the recipe and indicium are printed on paper.

16. A method of printing a recipe, comprising the steps of:
selecting a recipe;
selecting information from the recipe to form a coded indicium;
using the selected information to generate the coded indicium including information from the recipe; and
printing the recipe with the indicium.

17. The method according to claim 16, wherein the printing step includes printing the recipe and indicium on paper.

18. The method according to claim 17, wherein the printing step includes printing the recipe and indicium in the same paper based publication.

19. The method according to claim 17, wherein the printing step includes, printing the recipe and indicium on the same page of a paper based publication.

20. The method according to claim 16, wherein the selected information includes a list of ingredients for preparing the recipe and/or steps for the preparation of the recipe.

21. The method of claim 1, wherein the digital information decoded additionally includes codes which identify particular portions of the digital data to the software as steps for preparing the recipe.
